(19) United States
(12) Patent Application Publication
(10) Pub. No.: US 2016/0282827 A1
(43) Pub. Date: Sep. 29, 2016

(54) METHOD FOR PROVIDING CUSTOM FIT SADDLE TREES

(71) Applicants: Robert DIADONE, Alexander, ME (US); Lisa Dereszewski, Alexander, ME (US)

(72) Inventors: Robert DIADONE, Alexander, ME (US); Lisa Dereszewski, Alexander, ME (US)

(21) Appl. No.: 15/081,254

(22) Filed: Mar. 25, 2016

Related U.S. Application Data
(60) Provisional application No. 62/138,851, filed on Mar. 26, 2015.

(51) Int. Cl. G05B 15/02; B33Y 50/02

(52) U.S. Cl. CPC G05B 15/02; B33Y 50/02

(57) ABSTRACT

A method for acquiring anatomical data from a particular horse, processing said data into appropriate fitting and sizing data for a saddle tree, and providing said processed data to a 3D printer for the creation of a custom fit saddle tree, using a mobile device to capture data from said horse and formatting the horse's data using proprietary algorithms, fuzzy logic, and heuristics.

### CROSS REFERENCE TO RELATED APPLICATIONS

This application claims priority to a provisional application, U.S. Ser. No. 62/138,851, filed Mar. 26, 2015, entitled Method And Apparatus For Providing Custom Fit Saddle Trees, by Diadone, Robert, et al., which is hereby incorporated by reference.

### BACKGROUND OF THE INVENTION

1. Technical Field

The present invention relates to the field of equestrian equipment, and more specifically, to a method for providing custom fit saddle trees using a mobile device to capture data and a 3D printer or CAD/CAM milling machine to produce the saddle tree. The method includes obtaining, storing, analyzing and transferring data to a database for the purposes of determining the proper contour of a saddle tree for the anatomy of a particular horse, and the transfer of said processed data to a 3D printer or CAD/CAM milling machine for the custom production of a saddle tree for said horse. The method further discloses apparatus which includes the data capture devices, the data transfer devices, the data storage devices, the data processing devices, and the data display devices, one or more of which may be integrated into a single device, such as a smartphone.

2. Description of Prior Art

There are millions of domestic horses in the United States and millions of enthusiastic horse riders. For hundreds of years, riders have placed saddles onto the backs of horses for the protection of the horse and the comfort and safety of the rider. Each horse provides a unique anatomy, onto which riders attempt to fit an appropriate saddle. Ideally, the contours of the underside of a saddle are designed to approximate the contours of a horse's back and flanks, as near as possible. The fewer gaps and pressure points between a saddle and the horse, providing the best surface contact between the saddle and the horse, the better the fit. However, the present state of the art for creating custom made saddles involves a high degree of expertise and experience from craftsmen, which is very expensive and time consuming. A custom made saddle is therefore often unavailable for the vast majority of horses.

In the absence of the availability of a custom made saddle designed for a particular horse, the average consumer/rider is forced to go with an “off the shelf” saddle, picking a size that they believe will fit their horse based on these general “bar” categories, discipline specifics, style and outward appearance, marketing, and a single measurement called the gullet measurement. The gullet measurement can typically range in size from 5″ to 9″ and represents the front of the saddle only. However, one number alone and horse type cannot address all the additional measurements and angles that go into the production of the saddle tree, i.e. rock, bar flare, spread, twist, etc., to make a determination on the quality of fit a saddle will be to the horse. A Quarter Horse Bar Tree for one company may be much wider or much narrower than another company's. This creates a significant problem in the equine manufacturing industry with respect to both terminology and basic understanding of saddle fit. In fact, most saddle fitters report that 90% of saddles they check do not fit the horse properly and pose a significant risk of harm to both horse and rider.

Correct saddle fit is more than just problematic as a financial and economic deterrent. Ill fitting saddles represent a primary safety issue for the user. Poorly fitted saddles subject the horse to acute and chronic pain, leading to loss of concentration and discomfort for the animal, a major contributor to personal injury in riders costing billions of dollars in losses, both economically and through medical claims and lost work time. The problem of poor fit leads to a host of additional expenses to the horse owner including, horse chiropractor care, expensive veterinary and supplementation expense, the necessity to purchase additional saddles, horse training, and in extreme cases the purchase of a new horse.

Examples of sizing/fitting difficulty for users abound. A horse's back is a dynamic object that is constantly in motion. It is also dynamic in that it changes shape with development from activity, and seasonally over time. While the back of a single horse may stay relatively stable over time, some deviation will occur necessitating a “best fit” choice for the user. As contemplated herein, “best fit” means a saddle tree having the shape and dimensions that most closely approximate the anatomy of the particular horse for which they are intended, so that when a “best fit” saddle made from that saddle tree is placed on a particular horse the performance and safety of that saddle is maximized and discomfort to the horse is minimized. In addition to sizing, “best fit” also takes into account additional factors, such as appropriateness for the intended use, rider characteristics such as height and weight, style, discipline, breed of horse, cost, quality, origin of manufacture, and other factors important to the user.

Because horse backs are as individual morphologically as their riders, while the saddle can easily be fit for the rider, no one saddle will fit all horses. The saddle fit industry is a large one and is comprised of professional saddle fitters who attempt to correct ill-fitting saddles by narrowing down saddle choices for the consumer, saddle tree makers who claim that their trees fit a greater majority of horses, specialty saddle pad makers who claim their pads will assist in a better fit of most saddles, and saddle manufacturers who claim their saddles have better elements for a better fit. In reality, the only way a saddle will fit optimally to a horse's back is if the tree is made specifically for that particular horse being fitted for a saddle.

What is needed, then, is a method for capturing and storing the geometry of a particular horse and the means for creating a custom fitting saddle for that horse that is accurate and inexpensive.

It is thus an object of the present invention to present a method and apparatus for determining the best fitting saddle design for a particular horse and using that information to create a custom saddle tree.

It is a further object of the present invention to present a method and apparatus for capturing data from the anatomy of a particular horse.

It is yet a further object of the present invention to present a method and apparatus for providing data captured a particular horse in a form conducive to use with a 3D printer.

It is yet a further object of the present invention to present a method and apparatus for providing data captured a particular horse in a form conducive to use with a 3D printer for creating a custom fit saddle tree.

It is yet a further object of the present invention to present a method and apparatus for providing data captured a particular horse in a form conducive to use with a CAD/CAM milling machine.

It is yet a further object of the present invention to present a method and apparatus for providing data captured a particular horse in a form conducive to use with a CAD/CAM milling machine for creating a custom fit saddle tree.

Other objectives of the present invention will be readily apparent from the description that follows.

### SUMMARY OF THE INVENTION

The present invention concerns creating the best saddle tree for a particular horse. A saddle tree is an internal form around which a saddle is built and the part of the saddle that must make contact with the horse's back in order for the saddle to perform properly and ensure safety. Saddles with different external features and aesthetics may be made using the same saddle tree. There are fewer styles of saddle trees than there are saddles.

The present invention uses image scanning and capture technology to capture raw data, converts that data into a three dimensional (3D) point cloud structure, then uses algorithms, fuzzy logic, and heuristics to create data structures suitable for use with a 3D printer or a CAD/CAM milling machine.

The present invention comprises a method and apparatus for capturing fitting and sizing data for saddle trees using a mobile device, including but not limited to a smart phone, a computer, a tablet (such as an iPad®), or wearable technology operated locally or remotely. The method includes, but is not limited to, obtaining, storing, analyzing and transferring data to a database for the purposes of providing input data to computer software programs suitable for controlling the operation of a 3D printer or a CAD/CAM milling machine, employing algorithm led data fields for deviation analysis, self-similarity analysis, field dynamics and/or field interaction based interpretation of 3D image data. Algorithm led data fields include, but are not limited to, 3D scanned data fields of: static-static, static-dynamic, and/or dynamic-dynamic objects.

Other features and advantages of the invention are described below.

### DESCRIPTION OF THE DRAWINGS

FIG. 1 depicts a schematic of the data capture and analysis process.

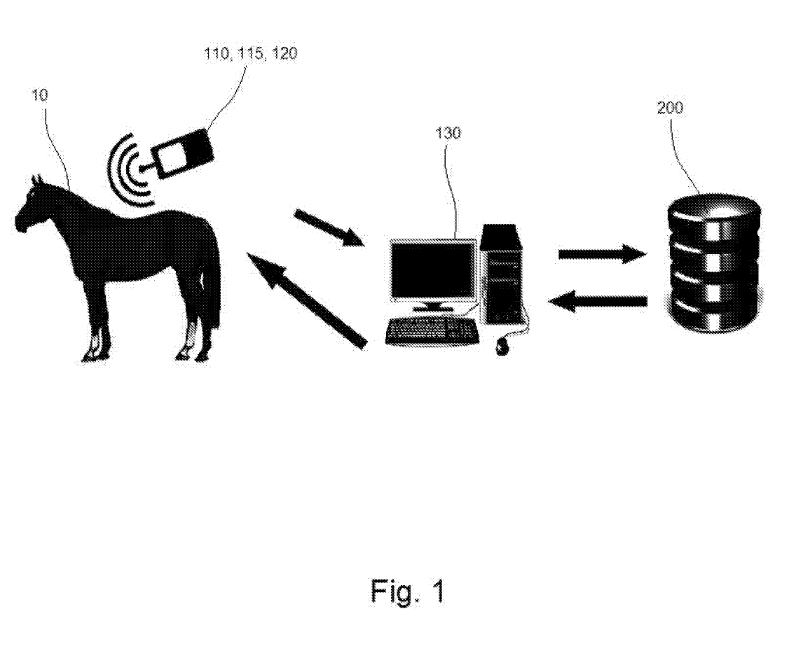

FIG. 2 depicts a representation of the 3D point cloud structure for the captured data.

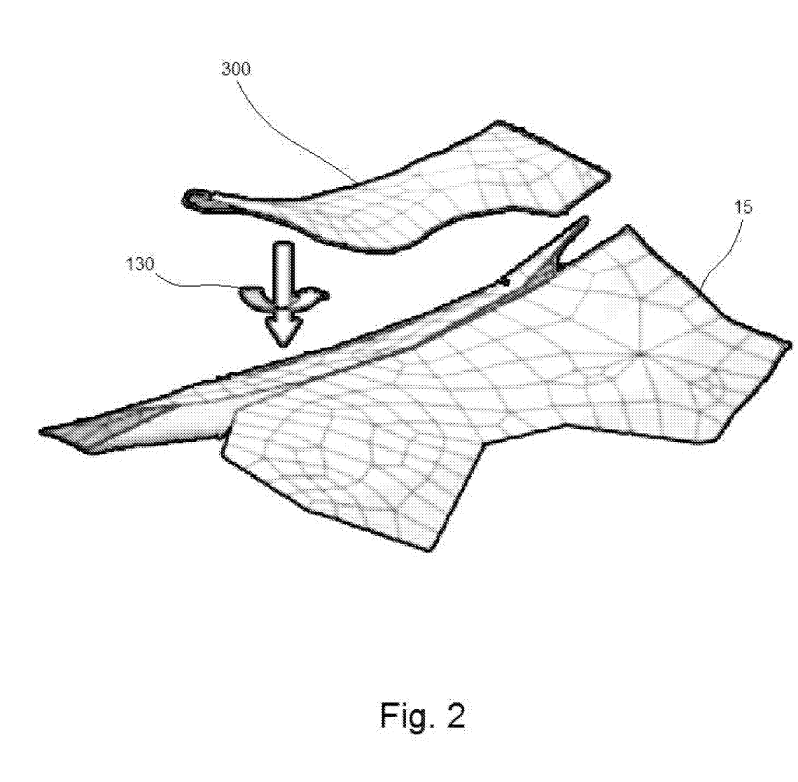

FIG. 3 depicts a flow chart of one embodiment of the method of the present invention.

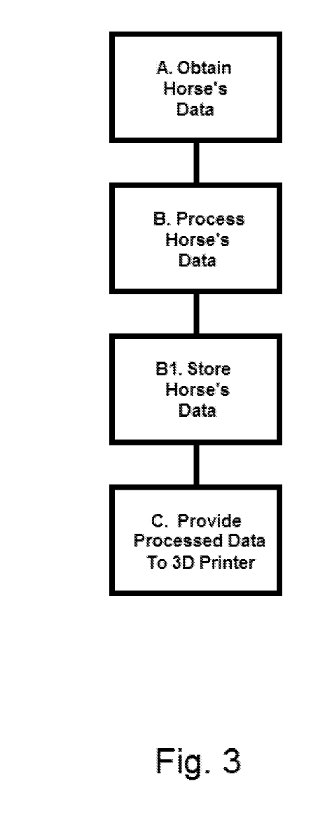

FIG. 4 depicts a flow chart of another embodiment of the method of the present invention.

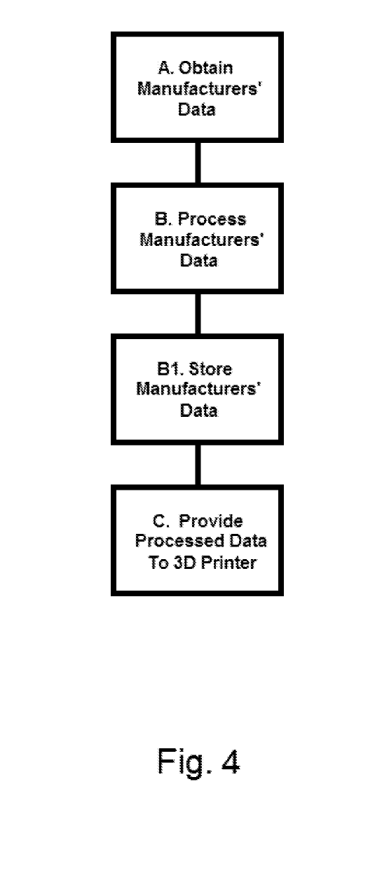

### DETAILED DESCRIPTION OF THE INVENTION

The present disclosure relates to providing a user with information based upon the user's 3D scan of one or more horses' 10 backs 15. More specifically, the present disclosure relates to obtaining data that is then converted for use with a 3D printer or a CAD/CAM milling machine in order to create a custom fit saddle tree.

The present invention uses a remote peripheral device 110 and a mobile application 120 for data capture relevant to a particular horse's 10 anatomy, then processes that data into a form that is suitable for use with computer software programs 130. Saddle trees are then created using 3D printing from the data capture process, or alternatively, by using a CAD/CAM milling machine.

The present invention contemplates various means for data capture. One means is through the use of stereophotogrammetry. Stereophotogrammetry uses multiple photographic images taken with a scanner 115 from different positions in order to determine the 3D coordinates of specific points on a target surface, in this case, a horse's back 15. This approach typically requires the placement of special markers and/or texture on the surface, and then the capture of images including the markers and/or texture. Accurate image capture using stereophotogrammetry is dependent on camera digital resolution, f-number, and focal length, and the overall accuracy of the image capture technology. Currently available smartphones have built-in cameras that are of sufficient quality as to be able to capture usable images. The use of smartphones allows for easy transfer of those images to a computer for processing. In addition, other factors are taken into account when processing images, including ambient light conditions, image blur, the number of photos required, the distance of the camera to the target surface, the angle of camera to the target surface, even the brand of smartphone.

Another means of data capture uses IR scanning technology 115. This technology currently provides more accurate data capture than smartphone-based camera stereophotogrammetry, but requires more expensive, dedicated equipment. The use of IR scanning technology 115 for data capture of the target surface may be more appealing in the future if this technology becomes integrated with mobile technologies. IR scanning technology 115 is currently being used and is contemplated to be included in the scope of the apparatus.

The captured data is converted into 3D coordinates 300 defining the horse's back 15 and flanks. Manufacturer specific saddle trees are also stored in a database 200 as 3D coordinates. The 3D coordinate data 300 may be stored as any of the following: a point cloud of x,y,z data, a mesh defining the surface, or a listing of fitted splines. Other appropriate representations are also contemplated. Saddle tree data includes the following, at a minimum: gullet width, bar angle, rocker angle, twist angle, and bar length.

The algorithm used to determine the design of the saddle tree uses non-linear optimization techniques to align the horse's back 15 to the saddle tree by minimizing the residual between surface data, for example, using multi-conjugate gradient method or genetic algorithm. Heuristics specific to saddle fitting are implemented to constrain the optimization. The genetic algorithm (GA) is a search heuristic that mimics the process of natural selection (also sometimes called a metaheuristic) and is routinely used to generate useful solutions to optimization and search problems. Genetic algorithms belong to the larger class of evolutionary algorithms (EA), which generate solutions to optimization problems using techniques inspired by natural evolution, such as inheritance, mutation, selection, and crossover. The algorithm of the present invention for determining the design of a saddle tree is a method for defining the saddle tree (data) to the measured horseback profile (reference), with the weighted mean squared error between the two datasets being minimized using an optimization technique.

The means for optimization may be implemented using the iterative closest point method (ICP), a genetic algorithm (GA), or a hybrid ICP-GA approach. Optimization may be constrained with both spatial limits and heuristics determined from saddle fitting expertise, to avoid adopting a non-optimal alignment solution in local minima.

The method of the present invention contemplates the following steps:

1. User input: A user downloads a mobile application 120 to their smart peripheral. The user inputs information requested by the mobile application 120 to identify the project, including information about the horse 10 to be fitted. The user acquires one or more photos, 3D scans, or equivalent point cloud file using the data acquisition peripheral (including wired and wireless imaging peripherals) operated locally or remotely. Imaging may include, but is not limited to, targeted or non-targeted stereophotogrammetry, dense surface modeling (DSM), single image photography, or 3D scanning including but not limited to IR, PET, CAT, MRI, sonar or other electromagnetic scan technology. Images may be obtained via the use of wireless peripherals which include, but not limited to, smart peripherals, i.e., smartphones, wrist bands, glasses, hand-held computers, tablets, drones, or hand held or wearable peripherals. The user confirms proper data acquisition.

2. File transfer: Images are processed remotely or transferred raw or in file format electronically to a database 200. Images formats include all file formats associated with current and future scan and stereophotogrammetry devices.

3. Data processing: The database 200 receives image files and assigned numerical and consumer information, i.e., information collected for the purpose of sizing, comparisons, data extraction, database reference, and other purposes deems significant for use with the method of the present invention. An algorithm optimizes the fit of the client point cloud and translates the data into a form usable by computer programs that control the operation of a 3D printer or a CAD/CAM milling machine.

4. Printing/milling: The processed data is provided to a computer program which controls the operation of a 3D printer, which prints a saddle tree based on the processed data. The resulting saddle tree is custom fitted to the horse 10 from which the initial data was acquired in Step 1. Alternatively, the processed data is provided to a computer program which controls operation of a CAD/CAM milling machine, which mills a saddle tree based on the processed data.

What has been described and illustrated herein is a preferred embodiment of the invention along with some it its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect. Other embodiments not specifically set forth herein are also within the scope of the following claims, whereby modifications and variations can be made to the disclosed embodiments of the present invention without departing from the subject of the invention as defined in the following claims.

I claim:

1. A method for providing a custom fit saddle tree, said method comprising the following steps:
A. obtain anatomical data from a horse;
B. process said anatomical data into appropriate fitting and sizing data for a saddle tree; and
C. provide said processed data to a 3D printer for the creation of a custom fit saddle tree;
whereby
steps A through C occur in the order presented.

2. The method of claim 1 further comprising the following step:
B1. store said anatomical data obtained from said horse in a database;
whereby
step B1 follows step B.

3. The method of claim 1 further comprising the following step:
A1. obtain a device to obtain anatomical data from said horse;
whereby
step A1 occurs before step A.

4. The method of claim 3 wherein the device used to obtain anatomical data from said horse is a mobile device.

5. The method of claim 1 wherein a mobile device is used to obtain anatomical data from said horse in step A.

6. The method of claim 1 wherein processing said horse's anatomical data in step B includes formatting said horse's anatomical data.

7. The method of claim 6 wherein in step B the anatomical data obtained from the horse is formatted into three dimensional coordinates.

8. The method of claim 6 wherein in step B the anatomical data obtained from the horse is formatted into a three dimensional point cloud structure.

9. The method of claim 6 wherein in step B the anatomical data obtained from the horse is formatted into a three dimensional mesh structure.

10. The method of claim 6 wherein in step B the anatomical data obtained from the horse is formatted into a three dimensional listing of fitted splines.

11. The method of claim 6 wherein in step B the anatomical data obtained from the horse is formatted into three dimensional surface geometry.

12. The method of claim 1 wherein acquiring anatomical data from said horse in step A is through the use of stereophotogrammetry.

13. The method of claim 12 further comprising the following step:
A1. place a plurality of markers onto at least a portion of the back and flanks of the horse;
whereby
step A1 occurs before step A.

14. The method of claim 1 wherein acquiring anatomical data from said horse in step A is through the use of three dimensional scanning, using one or more technologies of the following group: IR scanning technology, PET scanning technology, CAT scanning technology, MRI scanning technology, and sonar.

15. The method of claim 1 wherein the anatomical data obtained from the horse comprises a subset of data related to anatomical features of at least a portion of the back and flanks of the horse.

16. The method of claim 1 wherein the anatomical data obtained from the horse comprises a three dimensional map of the topography of at least a portion of the back and flanks of the horse.

17. The method of claim 3 wherein the device used to obtain anatomical data from the horse is one of the group of a smartphone, a tablet computing device, a laptop computer, a notebook computer, smart glasses, a wearable computer, a drone, a handheld scanner, and an IR scanner.

18. The method of claim 3 wherein the device used to obtain anatomical data from the horse comprises a plurality of wearable sensors.

19. The method of claim 5 wherein the mobile device used to obtain anatomical data from the horse is one of the group of a smartphone, a tablet computing device, a laptop computer, a notebook computer, smart glasses, a wearable computer, a drone, a handheld scanner, and an IR scanner.

20. The method of claim 5 wherein the mobile device used to obtain anatomical data from the horse comprises a plurality of wearable sensors.

21. The method of claim 1 wherein the processing performed in step B comprises one or more of the following: deviation analysis of the data, self-similarity analysis of the data, field dynamics and field interaction based interpretation of three dimensional image data.

22. The method of claim 1 wherein the processing performed in step B comprises optimization techniques to align the horse's back to the saddle tree by minimizing or obtaining a target deviation between surface data by using any conjugate gradient method.

23. The method of claim 1 wherein the processing performed in step B comprises optimization techniques to align the horse's back to the saddle tree by minimizing or obtaining a target deviation between surface data by using a genetic algorithm.

24. The method of claim 23 wherein the genetic algorithm uses a weighted deviation comparison between the saddle tree data and the horse's anatomical data.

25. The method of claim 1 wherein the processing performed in step B comprises optimization techniques to align the horse's back to the saddle tree by minimizing or obtaining a target deviation between surface data by using an iterative closest point algorithm.

26. The method of claim 25 wherein the iterative closest point algorithm uses a weighted deviation comparison between the saddle tree data and the horse's anatomical data.

27. A method for providing a custom fit saddle tree, said method comprising the following steps:
A. obtain data from a plurality of manufacturers, whereby for each said manufacturer said data comprises specifications for one or more saddle trees manufactured by said manufacturer;
B. process said data into appropriate fitting and sizing data for a saddle tree; and
C. provide said processed data to a 3D printer for the creation of a custom fit saddle tree;
whereby
steps A through C occur in the order presented.

28. The method of claim 27 further comprising the following step:
B1. store said data obtained from said manufacturers in a database;
whereby
step B1 follows step B.

29. The method of claim 27 wherein processing said manufacturers' data in step B includes formatting said data.

30. The method of claim 29 wherein in step B the data is formatted into three dimensional coordinates.

31. The method of claim 29 wherein the data is formatted into a three dimensional point cloud structure.

32. The method of claim 29 wherein the data is formatted into a three dimensional mesh structure.

33. The method of claim 29 wherein the data is formatted into a three dimensional listing of fitted splines.

34. The method of claim 29 wherein the data is formatted into three dimensional surface geometry.

35. The method of claim 27 wherein the processing performed in step B comprises one or more of the following: deviation analysis of the data, self-similarity analysis of the data, field dynamics and field interaction based interpretation of three dimensional image data.

36. The method of claim 27 wherein the processing performed in step B comprises optimization techniques to align the horse's back to the saddle tree by minimizing or obtaining a target deviation between surface data by using any conjugate gradient method.

37. The method of claim 27 wherein the processing performed in step B comprises optimization techniques to align the horse's back to the saddle tree by minimizing or obtaining a target deviation between surface data by using a genetic algorithm.

38. The method of claim 37 wherein the genetic algorithm uses a weighted deviation comparison between the saddle tree data and the horse's anatomical data.

39. The method of claim 27 wherein the processing performed in step B comprises optimization techniques to align the horse's back to the saddle tree by minimizing or obtaining a target deviation between surface data by using an iterative closest point algorithm.

40. The method of claim 39 wherein the iterative closest point algorithm uses a weighted deviation comparison between the saddle tree data and the horse's anatomical data.

41. The method of claim 27 wherein the specifications described in step A comprise saddle geometry.

42. The method of claim 27 wherein the specifications described in step A comprise one or more of the group of gullet measurement, rock, bar flare, bar length, rocker angle, spread, and twist angle.

43. A method for providing a custom fit saddle tree, said method comprising the following steps:
A. obtain anatomical data from a horse;
B. process said anatomical data into appropriate fitting and sizing data for a saddle tree; and
C. provide said processed data to a CAD/CAM milling machine for the creation of a custom fit saddle tree;
whereby
steps A through C occur in the order presented.

44. The method of claim 43 further comprising the following step:
B1. store said anatomical data obtained from said horse in a database;
whereby
step B1 follows step B.

45. The method of claim 43 further comprising the following step:
A1. obtain a device to obtain anatomical data from said horse;
whereby
step A1 occurs before step A.

46. The method of claim 43 wherein processing said horse's anatomical data in step B includes formatting said horse's anatomical data.

47. The method of claim 43 wherein acquiring anatomical data from said horse in step A is through the use of stereophotogrammetry.

48. The method of claim 47 further comprising the following step:
A1. place a plurality of markers onto at least a portion of the back and flanks of the horse;
whereby
step A1 occurs before step A.

49. The method of claim 43 wherein acquiring anatomical data from said horse in step A is through the use of three dimensional scanning, using one or more technologies of the following group: IR scanning technology, PET scanning technology, CAT scanning technology, MRI scanning technology, and sonar.

50. The method of claim 45 wherein the device used to obtain anatomical data from the horse is one of the group of a smartphone, a tablet computing device, a laptop computer, a notebook computer, smart glasses, a wearable computer, a drone, a handheld scanner, and an IR scanner.

51. A method for providing a custom fit saddle tree, said method comprising the following steps:
A. obtain data from a plurality of manufacturers, whereby for each said manufacturer said data comprises specifications for one or more saddle trees manufactured by said manufacturer;
B. process said data into appropriate fitting and sizing data for a saddle tree; and
C. provide said processed data to a CAD/CAM milling machine for the creation of a custom fit saddle tree;
whereby
steps A through C occur in the order presented.

52. The method of claim 51 further comprising the following step:
B1. store said anatomical data obtained from said manufacturers in a database;
whereby
step B1 follows step B.

53. The method of claim 51 wherein processing said manufacturers' data in step B includes formatting said data.
